(19) United States
(12) Patent Application Publication
(10) Pub. No.: US 2013/0284799 A1
(43) Pub. Date: Oct. 31, 2013

(54) KNOCK DOWN RIGID BOX

(71) Applicants: Chris Hallam, Bradford (GB); John Douglas Hudson, Harrogate (GB)

(72) Inventors: Chris Hallam, Bradford (GB); John Douglas Hudson, Harrogate (GB)

(73) Assignee: CONCEPT PACKAGING SERVICES LIMITED, Bradford (GB)

(21) Appl. No.: 13/884,300

(22) PCT Filed: Nov. 30, 2011
(86) PCT No.: PCT/GB11/52362

§ 371 Date: Jul. 17, 2013

(30) Foreign Application Priority Data
Nov. 9, 2010 (GB) 1018882.9

(51) Int. Cl. B65D 5/36; B31B 17/74

(52) U.S. Cl. CPC B65D 5/3621; B31B 17/74
USPC 229/126; 493/110; 493/102; 493/56

(57) ABSTRACT

A method for manufacturing a hinged lid paper covered rigid box which can be 5 knocked down, the method comprising covering a rigid board blank with paper, whereby the blank comprises a first sidewall, a second sidewall, a third sidewall and a fourth sidewall, the first sidewall being hingedly connected to the second sidewall, the second sidewall being hingedly connected to the third sidewall, the third sidewall being hingedly connected to the fourth sidewall and 10 the fourth sidewall being hingedly connected to the first sidewall, whereby the sidewalls can be in a knock down state and the method further comprising erecting the box in which the sidewalls are moved to an erect state by a parallelogram movement.

### FIELD OF THE INVENTION

The present invention relates to methods of manufacturing a one piece paper covered box with a hinged lid which can be supplied in knock down form and to such manufactured boxes.

### BACKGROUND OF THE INVENTION

Paper covered hinged lid boxes are commonplace. Their manufacture is usually time-consuming and they have to be supplied in set up three dimensional state. This is particularly problematic and costly. It also has a significant negative environmental impact.

Typically the box or base section is manufactured from solid board covered with paper. The paper is fully coated with glue and then manually wrapped around the base which has been erected into its final three dimensional state. The lid section is again paper over solid board but is made in a flat form. The two components are then glued together to form a complete package. Often the lid section also has a front section which drops down over the base and is closed by a securement means such as press studs or magnets.

It would be advantageous to be able to create a similar construction but which ships flat to the point of packing.

Preferred embodiments of the present invention seek to overcome or at least mitigate the problems of the prior art.

### SUMMARY OF THE INVENTION

According to the present invention there is provided a method for manufacturing a hinged lid paper covered rigid box which can be knocked down for shipping to the point of use.

There is also provided a construction for achieving the above.

The present invention in a first aspect provides a method for manufacturing a hinged lid paper covered rigid box which can be knocked down, the method comprising covering a rigid board blank with paper, whereby the blank comprises a first sidewall, a second sidewall, a third sidewall and a fourth sidewall, the first sidewall being hingedly connected to the second sidewall, the second sidewall being hingedly connected to the third sidewall, the third sidewall being hingedly connected to the fourth sidewall and the fourth sidewall being hingedly connected to the first sidewall, whereby the sidewalls can be in a knock down state and the method further comprising erecting the box in which the sidewalls are moved to an erect state by a parallelogram movement.

Suitably, the box can have the covering paper applied in the flat state. This makes it more suitable for easier or more automatic assembly.

Suitably the box can be made from two components, the first component being for a lid, the second component being for the main body of the box.

Suitably, the blank is covered with paper and subsequently die cut to shape. This makes the covering step easier. Alternatively, the blank is die cut to shape and subsequently covered with paper. This does away with raw edges. Suitably, the paper is applied when wet and the folds applied to the corners while still wet.

Suitably, the cover paper overlies the edges of the blank and is folded over to cover the edges thereof.

Alternatively, the cover paper overlies and is folded over only some of the edges of the blank. Suitably, the cover paper overlies and is folded over only the edges of the blank that are visible in the made-up state.

Suitably, a sidewall is connected to an adjacent sidewall by a glue flap.

Suitably, the box comprises a base. Suitably, the base construction is of a folding base type. Suitably, the base construction is one of an envelope, crash lock or tuck end constructions.

Suitably, a side wall comprises a double walled side wall that has two panels glued together in a face-to-face relationship. Suitably, the double walls are spaced from the corners so that the walls are of a single thickness at the corners. Suitably all of the side wall panels are of this type.

Suitably, the box comprises a lid.

The present invention in a second aspect provides a hinged lid paper covered rigid box that can be in a knock down or made up state, the box comprising a rigid board covered with paper, a first sidewall, a second sidewall, a third sidewall and a fourth sidewall, the first sidewall being hingedly connected to the second sidewall, the second sidewall being hingedly connected to the third sidewall, the third sidewall being hingedly connected to the fourth sidewall and the fourth sidewall being hingedly connected to the first sidewall, whereby the sidewalls can be in a knock down state and the box is configured whereby in erecting the box the sidewalls are moved to an erect state by a parallelogram movement.

Suitably, the cover paper is folded over the edges of the blank to cover the edges thereof.

Alternatively, the cover paper is folded over only some of the edges of the blank. Suitably, the cover paper is folded over only the edges of the blank that are visible in the made-up state.

Suitably, a sidewall is connected to an adjacent sidewall by a glue flap.

Suitably, the box comprises a base. Suitably, the base construction is of a folding base type. Suitably, the base construction is one of an envelope, crash lock or tuck end constructions.

Suitably, a side wall comprises a double walled side wall that has two panels glued together in a face-to-face relationship. Suitably all of the side wall panels are of this type.

Suitably, the box comprises a lid.

### BRIEF DESCRIPTION OF THE DRAWINGS

FIG. 1 is a plan view of the solid board component for the box

FIG. 2 shows the board component superimposed over the cover paper prior to the final covering operations being performed.

FIG. 3 shows the covered box blank prior to secondary die cutting and joining

FIG. 4 shows the covered box blank after secondary die cutting.

FIG. 5 is a perspective view of the completed box in knock down state.

FIG. 6 shows the fully assembled box.

FIG. 7 shows how a similar box can be made from two separate covered pieces.

FIG. 8 shows a further embodiment with reduced cover paper folding required.

FIG. 9 shows an alternative embodiment with an alternative wall construction.

FIG. 10 shows a partly assembled box from the components of FIG. 9.

FIG. 11 shows a further partly assembled box from the components of FIG. 9.

### DESCRIPTION OF PREFERRED EMBODIMENTS

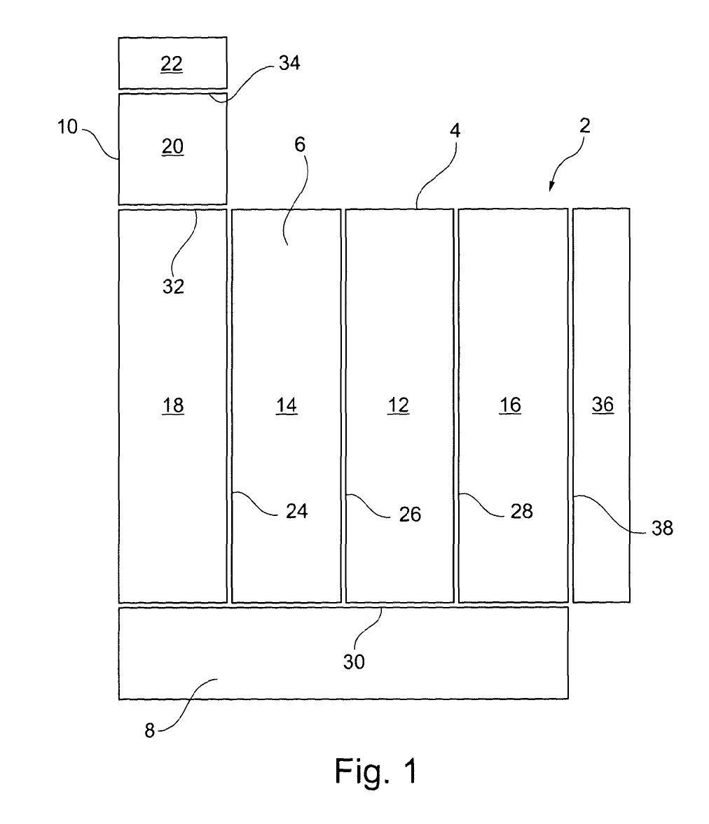

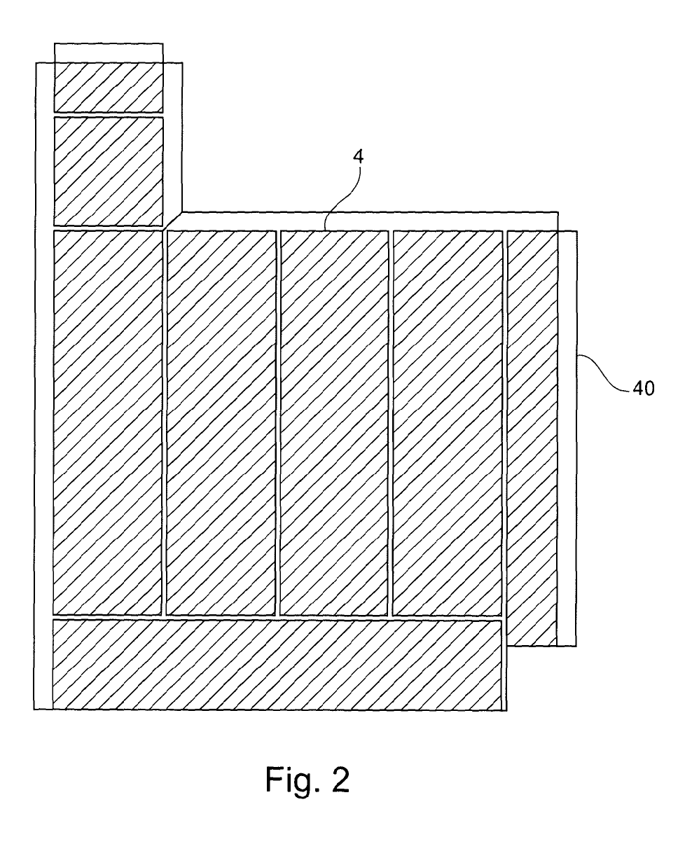

Referring to FIG. 1, a box 2 is made from solid board inner piece blank 4. The solid board is greater than 1.0 mm thick and preferably is less than 3.0 mm thick. Inner piece 4 consists of a sidewall 6, a base panel 8 and a lid panel 10. Sidewall 6 consists of a front sidewall 12 (first sidewall), left and right sidewalls 14, 16 (second and fourth sidewalls) and a rear sidewall 18 (third sidewall). Lid panel 10 consists of a top panel 20 and a front panel 22. Sidewall panels 12, 14, 16 and 18 are hingedly attached to each other along fold lines 24, 26 and 28. In a similar way the base panel 8 is hingedly attached to sidewall panel 6 along fold line 30 and top panel 20 is hingedly connected to rear sidewall panel 18 along fold line 32. Top panel 20 is in turn hingedly connected to front panel 22 along fold line 34. Finally a glue lap 36 is hingedly connected to right sidewall 16 along fold line 38. The blank 4 as described can be made from one piece of material and the hinged connection described be made by use of a number of methods of creating weakening lines such as routing or scoring or can be made from discrete pieces and the various panels can become hingedly attached once the front cover paper 40 and rear cover 42 (see FIG. 2) paper are applied.

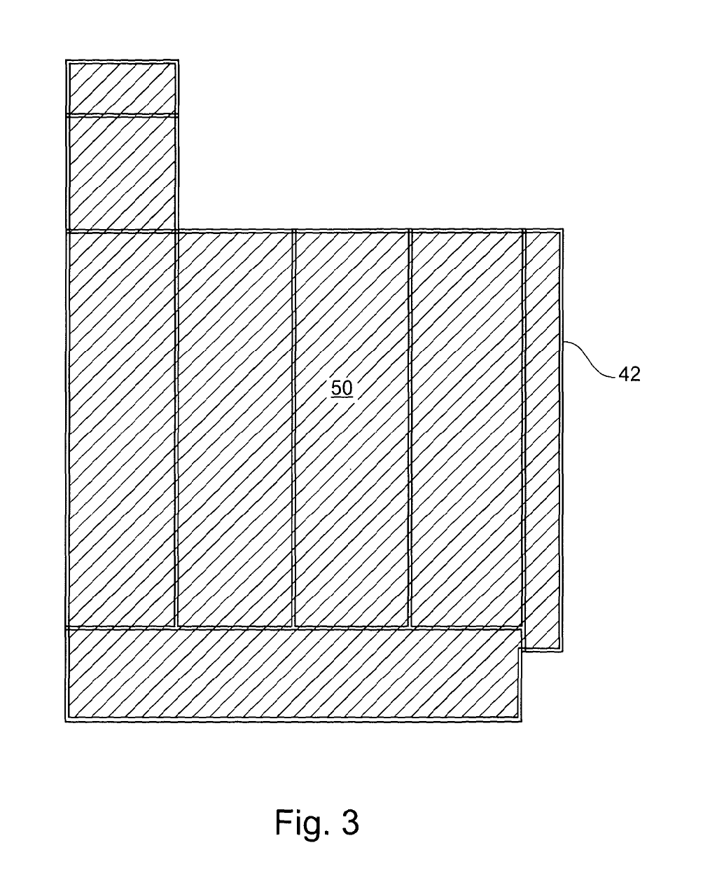

Referring to FIG. 2 the front cover paper 40 is glued out across its full reverse surface and placed glued side up. The solid inner piece blank 4 (or component parts) is superimposed on the front cover paper 40. Any overhanging edges of the front cover paper 40 are then brought around the edges of inner piece 4 to create neat covered ends. The rear cover paper 42 (shown in FIG. 3) is then applied to the opposite side of the inner piece blank 4. The end result is a substantially fully covered inner piece blank 4.

FIG. 3 shows the substantially covered box blank 50

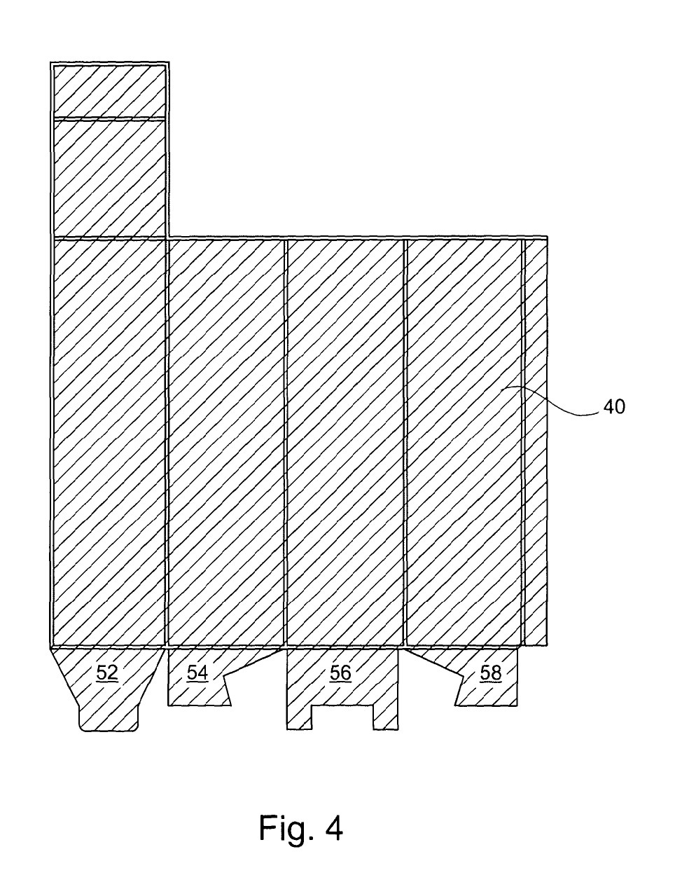

FIG. 4 shows box blank 50 after it has been through a process known as die cutting. In this process covered base panel 8 is profile cut to form separate panels 52, 54, 56 and 58 for a base for the made up box 2. In this instance the base shown is known as an envelope base and is common in folding cartons. Other folding carton base constructions can also be employed such as a crash lock base or a tuck end.

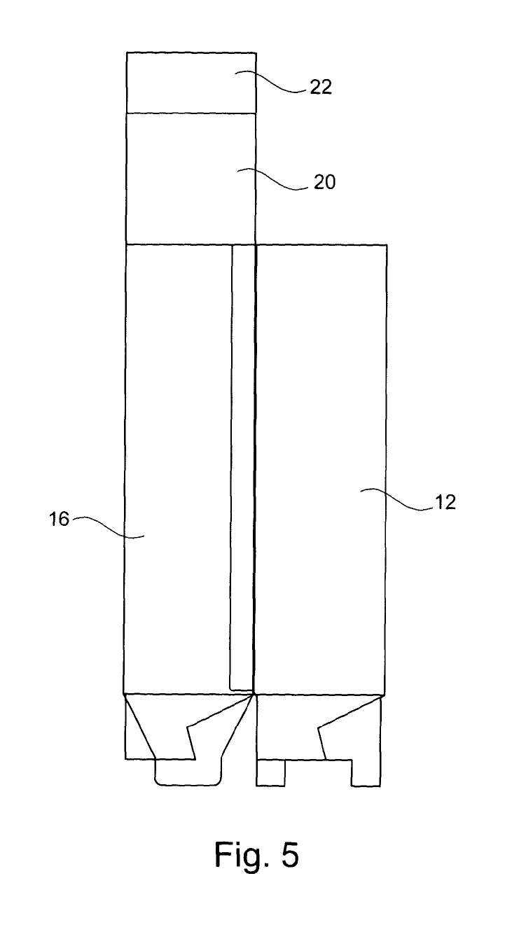

FIG. 5 shows a fully assembled box 2 in knock down state, in which the front side wall is in a face to face relationship with the third sidewall. Glue lap 36 is joined to sidewall panel 18 to form a flat tube. The join is typically made with adhesive. The box can be shipped to the point of packing in a substantially flat state.

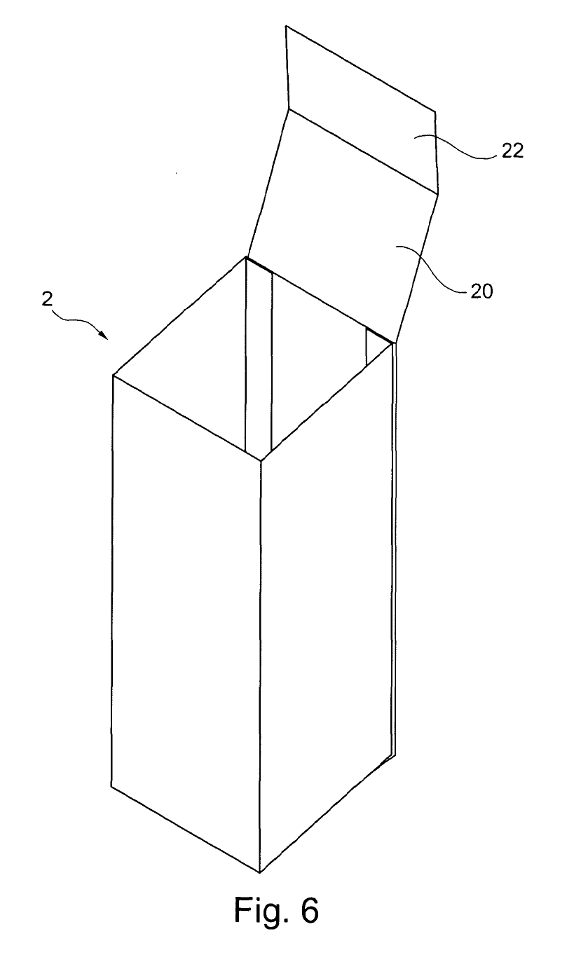

FIG. 6 shows a fully erected box ready to accept its contents. In order to erect the box from the flat blank 50 pressure is applied to opposing fold lines to open the flat tube. The tube is opened until it is substantially square or rectangular in its footprint. It will be appreciated from the construction described above that the tube will move to its erect construction with the side walls 12, 14, 16 and 18 moving in a parallelogram fashion, opposite walls remaining substantially parallel. The side walls define a parallelogram in the knock down state. The side walls 12, 14, 16 and 18 are hingedly connected to form a parallelogram linkage. The elements of the envelope base are assembled in a known manner to form the base of the box. In the case of a crash lock base the base elements are preglued in a known manner when the glue lap is adhered and the base erects automatically when the box is erected.

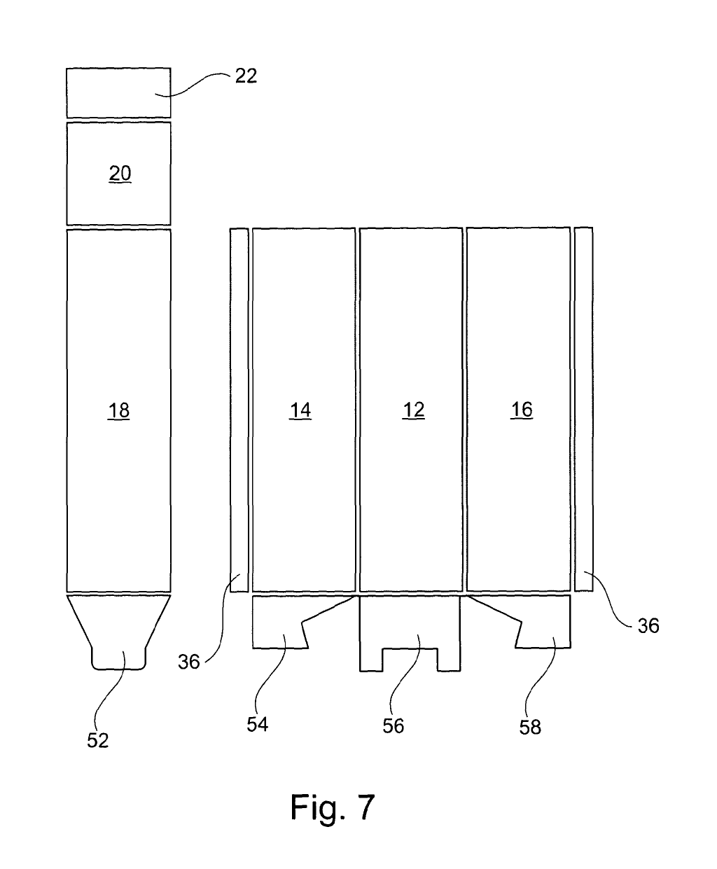

FIG. 7 shows how the same box can be made form 2 separate covered pieces. In this instance there are 2 glue laps which can be configured both on one component or alternatively one glue lap can be present on each component. FIG. 7 is simplified to show the basic construction but the parts are manufactured in the same manner as described before with a solid board inner and a front and rear cover paper and a secondary die cutting process.

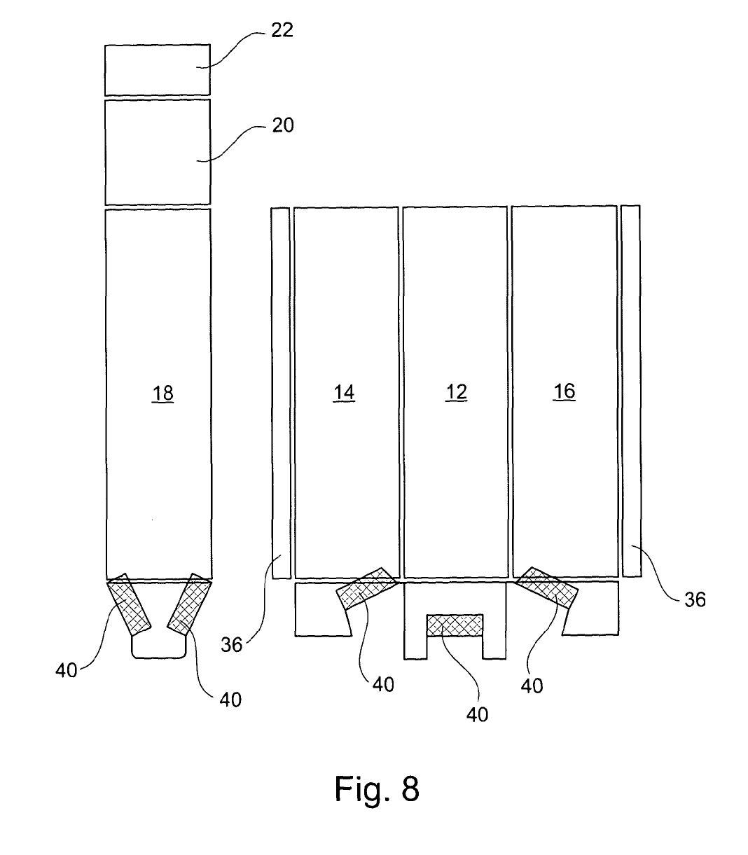

FIG. 8 shows a two-part construction similar to FIG. 7. However, in the partly constructed embodiment shown in FIG. 7, the outer cover paper 40 is shown folded over the base only over those five edges of the base that are visible after construction of the box. This saves on the required number of folds thus making the assembly process more efficient. In this version the base construction is cut before the outer cover paper is applied and the outer cover paper is folded around the edges of the base to finish the construction neatly.

In a further version the outer cover paper can be profiled so as to substantially overlie the pre die cut base panels and avoid the need to turn the edges over onto the inside.

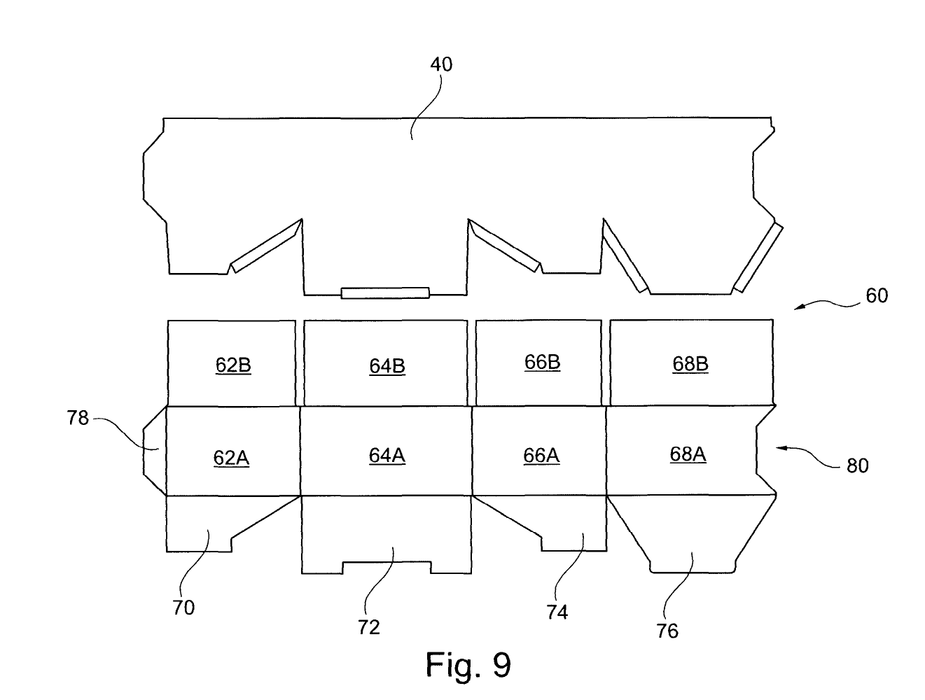

FIG. 9 shows an alternative side wall arrangement. In this embodiment the board can be thinner, typically 750-1000 microns, and the side walls are formed from double-thickness walls. It should be noted that the double walls are spaced from the corners so that the walls are of a single thickness at the corners. Given the board thickness, a double wall at the corners would cause the paper to crack or burst if creased or scored. A paper cover 40 is shown and a rigid board blank 60. The blank 60 comprises a first side wall 62A, 62B, a second side wall 64A, 64B, a third side wall 66A, 66B and a fourth side wall 68A, 68B. The blank further comprises a base made up of base panels 70, 72, 74 and 76. The blank further comprises a glue lap 78 on the first side wall and a corresponding cut-out portion 80 on the fourth side wall.

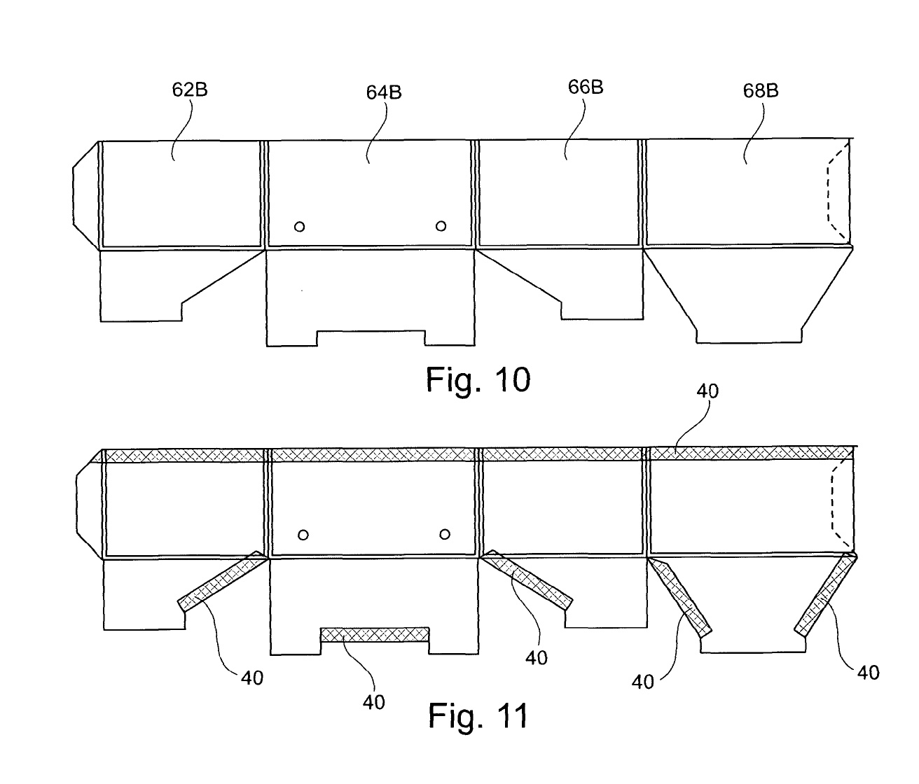

In a method of manufacturing a box from the blank 60 glue is applied to each of panels 62A, 64A, 66A and 68A then panel 62B is folded onto the glued side of panel 62A in a face-to-face relationship, and respectively for each of panels 64B, 66B and 68B forming the double walled construction shown in FIG. 10. The cover paper 40 is then applied and folded over, again showing only the exposed, i.e. outside the box and visible from the exterior when the box is made up, edges of the base being covered. When the box is assembled the glue lap 78 fits into the cut out portion 80 and is glued to the folded down part of fourth side wall 68B. This double walled construction is known to be particularly strong.

The front cover paper 40 is applied when the paper is still wet. 180 degree folds are applied to the corners, necessary for the box to fold flat, while the paper is still wet. The board will crack on the outer face but the paper hides this. If the 180 degree folds were made when the paper had dried the paper would crack.

In all cases at least one glue lap is adhered to a sidewall.

In all cases at least a front cover paper is adhered to the solid board inner. The rear cover paper optionally can not be used.

It is possible to produce the construction without the attached hinged lid. A lid can be attached afterwards or can be provided as a separate component.

The box can have a strong base capable of accepting and containing weighty items.

Attention is directed to all papers and documents which are filed concurrently with or previous to this specification in connection with this application and which are open to public inspection with this specification, and the contents of all such papers and documents herein by reference.

All of the features disclosed in this specification (including any accompanying claims, abstract and drawings), and/or all of the steps of any method or process so disclosed, may be combined in any combination except combinations where at least some of such features and/or steps are mutually exclusive.

Each feature disclosed in this specification (including accompanying claims, abstract and drawings) may be replaced by alternative features serving the same ,equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one or any novel combination, of the features disclosed in this specification (including any accompanying claims, abstract and drawings), or to any novel one, or any novel combination, of the steps of any method or process so disclosed.

1: A method for manufacturing a hinged lid paper covered rigid box which can be knocked down, the method comprising covering a rigid board blank with paper, whereby the blank comprises a first sidewall, a second sidewall, a third sidewall and a fourth sidewall, the first sidewall being hingedly connected to the second sidewall, the second sidewall being hingedly connected to the third sidewall, the third sidewall being hingedly connected to the fourth sidewall and the fourth sidewall being hingedly connected to the first sidewall, whereby the sidewalls can be in a knock down state and the method further comprising erecting the box in which the sidewalls are moved to an erect state by a parallelogram movement.

2: A method for manufacturing a hinged lid paper covered rigid box according to claim 1, in which the box has the covering paper applied in the flat state.

3: A method for manufacturing a hinged lid paper covered rigid box according to claim 1, in which the box is made from two components, the first component being for a lid, the second component being for the main body of the box.

4: A method for manufacturing a hinged lid paper covered rigid box according to claim 1, in which the blank is covered with paper and subsequently die cut to shape.

5: A method for manufacturing a hinged lid paper covered rigid box according to claim 1, in which the blank is die cut to shape and subsequently covered with paper.

6: A method for manufacturing a hinged lid paper covered rigid box according to claim 1, in which the paper is applied when wet and the folds applied to the corners while still wet.

7: A method for manufacturing a hinged lid paper covered rigid box according to claim 1, in which the cover paper overlies the edges of the blank and is folded over to cover the edges thereof.

8: A method for manufacturing a hinged lid paper covered rigid box according to claim 1, in which the cover paper overlies and is folded over only some of the edges of the blank.

9: A method for manufacturing a hinged lid paper covered rigid box according to claim 8, in which the cover paper overlies and is folded over only the edges of the blank that are visible in the made-up state.

10: A method for manufacturing a hinged lid paper covered rigid box according to claim 1, in which a sidewall is connected to an adjacent sidewall by a glue flap.

11. (canceled)

12. (canceled)

13. (canceled)

14: A method for manufacturing a hinged lid paper covered rigid box according to claim 1, in which a side wall comprises a double walled side wall that has two panels glued together in a face-to-face relationship.

15: A method for manufacturing a hinged lid paper covered rigid box according to claim 1, in which the double walls are spaced from the corners so that the walls are of a single thickness at the corners.

16: A method for manufacturing a hinged lid paper covered rigid box according to claim 1, in which all of the side wall panels are according to claim 15.

17. (canceled)

18: A hinged lid paper covered rigid box that can be in a knock down or made up state, the box comprising a rigid board covered with paper, a first sidewall, a second sidewall, a third sidewall and a fourth sidewall, the first sidewall being hingedly connected to the second sidewall, the second sidewall being hingedly connected to the third sidewall, the third sidewall being hingedly connected to the fourth sidewall and the fourth sidewall being hingedly connected to the first sidewall, whereby the sidewalls can be in a knock down state and the box is configured whereby in erecting the box the sidewalls are moved to an erect state by a parallelogram movement.

19: A hinged lid paper covered rigid box according to claim 18, in which the cover paper is folded over the edges of the blank to cover the edges thereof.

20: A hinged lid paper covered rigid box according to claim 18, in which the cover paper is folded over only some of the edges of the blank.

21: A hinged lid paper covered rigid box according to claim 18, the cover paper is folded over only the edges of the blank that are visible in the made-up state.

22: A hinged lid paper covered rigid box according to claim 18, in which a sidewall is connected to an adjacent sidewall by a glue flap.

23. (canceled)

24. (canceled)

25. (canceled)

26: A hinged lid paper covered rigid box according to claim 18, in which a side wall comprises a double walled side wall that has two panels glued together in a face-to-face relationship. Suitably all of the side wall panels are of this type.

27. (canceled)
